(19) United States
(12) Patent Application Publication
(10) Pub. No.: US 2001/0029830 A1
(43) Pub. Date: Oct. 18, 2001

(54) Device and method for testing music proficiency

(76) Inventor: Daniel Ira Rosen, Stateline, NV (US)

Correspondence Address: Daniel Rosen, Post Office Box 2963, Stateline, NV, 89449, US

(21) Appl. No.: 09/740,795

(22) Filed: Dec. 21, 2000

Related U.S. Application Data
(60) Provisional application No. 60/185,509, filed on Feb. 28, 2000.

(51) Int. Cl. G09B 15/04

(52) U.S. Cl. 84/478

(57) ABSTRACT

An electronic device and method for objective testing of proficiency in the performance of scales, arpeggios, and other standard musical exercises, and for evaluating the results according to recognized standards of perfect pitch and rhythm. A combination of microprocessor, digital signal processor, memory, and user interface (2, 5, 8, 3) creates and stores a test sequence as played by a musician, and also the same test sequence as produced by the testing device, the latter being made audible during the test (6). The microprocessor then analyses and compares the two versions of the test sequence, sending various kinds of reports to the output printer or video display (7).

### BACKGROUND—OF INVENTION

The present invention relates to testing devices, and more specifically to electronic testing devices.

### BACKGROUND—DESCRIPTION OF PRIOR ART

The Device and Method for Testing Music Proficiency addresses the need for an objective (i.e. mechanical) measure and means of comprehensive evaluation in musical performance art. Until now, and apart from subjective tests of musical excellence applied by the educated human ear itself, the only objective testing of musical excellence has been restricted to the following:

1. Determining the closeness of one single musically performed pitch to an absolute and predetermined pitch standard. This is accomplished, for example, by using a simple electronic tuner.

2. Determining the closeness of a rhythmic performance to a metronomic standard. No such device with this sole purpose has actually made it to the broad market.

3. Following the introduction of MIDI technology in the 1980s, it became possible to test both rhythm and pitch in the performance of musicians playing on MIDI instruments. Various computer software programs and devices have exploited this development (and others like it) in order to create applications for music education.

The present invention demonstrates for the first time how to make an objective and comprehensive evaluation of musical performance, one that is based on performance of the same standard repertoire of testing materials as has long been used in the historical development of the art. It provides for the same flexibility in the real-time testing environment as is enjoyed in traditional testing environments. It allows the user to instantly design each individual test according to any one of an infinite number of combinations and sequential orderings of all of the materials in the traditional testing repertoire. It may provide for performance in any one of the twelve keys, at any tempo, in any meter, and otherwise according to various other traditional parameters of performance. In short, this invention makes it possible for the first time to test musicians in a standard and traditional manner, while at the same time employing an objective means of measurement and evaluation.

Until the digital revolution, no real and practical possibility existed for the comprehensive testing of musical performance with reference to fully objective measures of proficiency. Digital technology provides the practical basis for the invention specified in this application, and like many other digital devices, it has, and can have, no analog electronic equivalents.

Digital technology has already resulted in devices that in some respects anticipate or move in the direction of a device for the objective and comprehensive testing of musical proficiency. Prior art shows, for example, various devices and also computer software for testing rudimentary music skills. However, it is important to recognize that the invention of a general-purpose and comprehensive testing device has no antecedents. Indeed, there is no indication that anybody has considered the development of such a device feasible, until the invention of the Device and Method for Testing Music Proficiency. This is because digital technology has not been the only element required for its invention. A practical method and design was also required, one that is in accord with the specifically musical demands of the traditional and conventional, but heretofore subjectively based, environment for testing musical performance. For it must be introduced seamlessly into this environment if it is to meet the practical needs and expectations of musicians. The method and design of this invention is, therefore, based on the method and design of a previous invention patented by the author of the present application (Harmonic Metronome, U.S. Pat. No. 5,515,764 (Rosen; Daniel).

With this in mind, the following related technologies will be discussed here: music tuners, metronomes, and particularly the Harmonic Metronome, computer music software, automatic accompaniment devices and software, and finally rudimentary music-skills testing devices.

Leading in the direction of a Device and Method for Testing Music Proficiency, various devices have addressed the need for precise measurement of pitch and rhythm in musical performance. Some of these devices have been produced under the descriptive category of “tuners,” which either play (often by the use of mechanical means) pitches tuned to a standard of absolute pitch, or which measure the accuracy of specific musical pitches played by a live performer on a musical instrument.

On the simplest level, the traditional pitch pipe or tuning fork provides a specific pitch as a reference for the musician who wants to calibrate his own pitch to that of a conventional standard accepted beforehand by the musical community. (For example, 440 cycles per second has been designated for the pitch called “A” as a universally recognized international convention.) The fork is struck with an object, and a pitch is sounded as a result.

The electronic tuner produces the reference pitch using mechanical means. And, after the development of electronic technologies, it was possible not only to provide reference frequencies, but also to measure electronically the pitch produced by the musician, and even to compare it with the standard enforced by convention. Thus, many electronic tuners have been equipped with microphone inputs to deliver the electronic signal from a microphone that registers the sound produced by a musical instrument (line inputs are used for electronic instruments). The resulting signal is compared to the designated standard and the result is displayed in some sensible form.

It is important to note that tuners are merely a device for comparing to a single reference pitch. Therefore, there is no need for them to respond to an input consisting of sequences of multiple pitches, such as can be found in the scales, arpeggios, and other configurations of pitch that make up the basic material of musical performance, per se. In other words, tuners are designed to respond to single pitches as single events, measured and evaluated as such. Tuners, moreover, do not measure musical time. In other words, far from being a comprehensive Device and Method for Testing Music Proficiency, tuners address a very specific and partial need to test the accuracy of specific pitches as individual and singular events. This function is but preparatory to musical performance, and the testing of it. It is a mere matter of putting the instrument in proper tune. It has little bearing on music performance as such, which is comprised of sequences of many pitches disposed in varying rhythms of great variety.

Another related area of technology is the metronome. All standard and traditional metronomes, both mechanical and electronic, provide a standard reference and measure of musical time against which the musician compares his own rhythmic performance, usually of a specific sequence of pitches, such as a scale. Emphasizing this point, until the invention and development of the Harmonic Metronome, no metronome was capable of addressing the need for a standard reference of pitch, which is the complimentary partner of rhythm in every musical event. The Harmonic Metronome is the only metronome that brings together in one system of measurement both rhythmic and pitched aspects of musical performance. Moreover, and very important to note for a proper understanding of what follows, it is the only metronome capable of serving as reference and measure of any one of the standard sequences of musical pitches and rhythms used in conventional music.

In order to accomplish this in a practical way, the Harmonic Metronome patent claimed a “method for producing a plurality of musical exercises, including scales, arpeggios, and etudes, consisting of sequences of perfectly timed and perfectly tuned musical pitches . . . ” Further, its method provides for combining all of those musical exercises in any sequence desired, with additional settings for changing at will and instantaneously all of the standard performance parameters, including key, meter, and tempo. In the present context, the word “instantaneous” refers to the digital computation and direct production of standard musical exercises, according to user-selected modifications, and without recourse to any additional programming or the input of any additional information. This can be done instantaneously because it relies on the algorithmic modification of information residing in a thoroughly comprehensive database that already has been stored in its entirety in the device's memory.

In this way, it is possible to support the entire testing repertoire in one small database that affords maximum ease of use. From a finite amount of information, a nearly infinite series of musical exercises are generated for use in performance practice—and in the case of the present patent, in music testing. (A good way to estimate the approximate proportions of the terms used here is to reflect on a subset of what is being described. Even if one restricted oneself only to the four principal kinds of scales and arpeggios (not counting, that is, a vast repertoire of other standard musical exercises), the number of possible combinations and modifications would render a database of exercises larger than any we can conceive. The task of the librarian alone would be insurmountable even with the aid of a computer. Yet, the Harmonic Metronome supports this range of possible exercises easily with approximately 4 Megs of conventional memory.)

As a practical matter, any other method would require the user first to program the device for any particular sequence of pitches that he wants to measure with the metronome. This is, from a practical point of view, in a real-life musical setting, a fatal constraint involving too much time, and/or necessitating too much prior knowledge of MIDI programming and/or music synthesizer and computer technology, etc. As such, the Harmonic Metronome presents the only practical solution to the puzzle of marrying the measurement of pitch and rhythm in one single metronome device. It does so in a manner that accommodates the needs of a player on any one of the musical instruments of the orchestra, or the voice. It has therefore been called a universal music accessory.

A metronome, and especially the Harmonic Metronome, may be considered a tool, and even a comprehensive tool, in the service of testing musical proficiency. However, the evaluation of the test in this case must be conducted entirely by the subjective human ear. In practice, the results depend on a subjective judgement that is made by the player or by a qualified listener about how closely the performance of the musician matched the performance of the metronome. This, therefore, returns us to a consideration of how we may answer the need for a method and means to provide a purely objective evaluation of musical performance.

Concurrently with the development of the Harmonic Metronome, programmers were working with computers to perform objective musical tests of certain kinds as adjuncts to the main function of the program, which was always elementary music education. Thus, computer music software that is related to musical performance, per se, has featured the use of specialized testing procedures, wherein the student is asked to do a specific task, which is then monitored and evaluated. Examples of such computer software are provided by “Music Ace,” by Harmonic Vision, the “Piano Discovery System,” by Jump! Music, and Mibac Music Lessons PC/Mac, by Mibac.

By way of illustrating how these programs typically work, a student may be asked to play a given note or sequence of notes on a keyboard attached to the MIDI port of a typical personal computer. If the student errs, the program highlights the error and displays a hint for correction. This provides a useful utility for teachers of elementary musical skills. However, it focuses on the particular skills required for very particular musical tasks that are individually designed for a specific pedagogical purpose at a predetermined point in a larger course of study. The test, as it were, is incorporated into the lesson. The function is teaching, and not testing, per se, which would bring with it additional needs and requirements. The music software that may be broadly construed as prior art for this application was not designed or marketed as a comprehensive application for testing music proficiency, nor is it capable of serving in such a function due to its extremely limited capacity. As the method of the present invention will show, the hardware associated with a typical personal computer is certainly capable of being used as a comprehensive device for testing music proficiency. But, the computer provides by itself no method for making it function as such. And the key point here is that no computer software to date has attempted to provide, let alone been able to demonstrate, a practical method and means by which the comprehensive testing of musical performance can be accomplished.

The same can be said, with respect to method and means, about a variety of actual musical devices that have been patented in the past. For example, consider the Apparatus for providing musical instruction, U.S. Pat. No. 5,841,051 (Segan; Marc H.). This device is designed to aid in the study of the piano keyboard, and it relies solely on that keyboard and on another unique and novel apparatus for the input of information from the performer (i.e. a specially designed and electronically wired hand pad). It should be noted here that the Device and Method for Testing Music Proficiency supports input from any one of the instruments of the orchestra, including electronic and MIDI instruments, and the voice. (The word comprehensive has been used advisedly in this application.) And, the Device and Method for Testing Music Proficiency does not specify a unique and novel apparatus for the input of performance data. It is comprised entirely of “off-the-shelf” components that have been used in other devices for different purposes, such as the microphone, a typical digital signal processor, and standard digital memory chips.

Another example of a device for music education is the Apparatus and method for interactive instruction of a student, U.S. Pat. No. 5,183,398, (Monte; Charles). This device measures the accuracy with which a performer can play a given sequence of pitches, chosen for pedagogical reasons. The device measures the accuracy of the performance, comparing it to a standard and objective reference, but since it is designed as a teaching device, it is also extremely limited in its functionality. The Apparatus and method for interactive instruction of a student employs musical sequences designed to teach specific and individual skills exclusively, and the sequences are not modified at will by the person using the device. Its arrangement (or, in other words, its combinations in sequence) of its various exercises is automatic, and not controlled by the user. Finally, its repertoire of musical exercises that are suitable for use in testing is by design too limited to make of it a practical, and comprehensive, means for testing music proficiency.

More highly developed in its design, the Musical Training Apparatus, U.S. Pat. No. 5,563,358 (Zimmerman; Thomas G.), presents many features in common with the Device and Method for Testing Music Proficiency. However, the essential difference between these two devices is well expressed here simply by the fact that one is labeled as a teaching, and the other as a testing, device. Like the previously described Patent, the Musical Training Apparatus is not intended or designed to answer the specific needs of a comprehensive musical testing device. First, it limits its functionality to a display that visually compares the temporal ordering and specific tuning of its individual reference pitches to the temporal order and specific tuning of student performed pitches. Because of the nature of the display, the device measures and indicates accuracy in performance only for each pitch individually. No provision is made, as with the Device and Method for Testing Music Proficiency, for composite evaluations of the performance—evaluations indicating, for example, what percentage of the pitches in the entire sequence were correct. More importantly, the Musical Training Apparatus does not provide in its analysis for a quantification of metronomic accuracy of the performance, although it does recognize metrical consistency, which is, however, something else entirely. The performance and recognition of correct meter does not require metronomic efficiency. It is sufficient for the performer to be approximate. And even more significantly, the Musical Training Apparatus cannot possibly store in its memory the full range of modifications and combinations of pitches and rhythms played in sequence that are conceivably possible to play and test. Just because it is designed not to function specifically as a music-testing device, but rather as an aid in teaching a specific temporal sequence of musical pitches, the Musical Training Apparatus does not provide for the instantaneous modification or transformation of the prerecorded sequences contained in its memory, nor for combining them automatically and at will with other musical sequences in multiple combinations. Thus, the Musical Training Apparatus does not provide a practical and comprehensive means for testing musical performance.

Again, to make the importance of this point perfectly clear, the Harmonic Metronome specified a “method for producing a plurality of musical exercises, including scales, arpeggios, and etudes, consisting of sequences of perfectly timed and perfectly tuned musical pitches . . . ” This is simply because proficiency in music in the real world has always been evaluated with reference to the performance of musical sequences of scales, arpeggios, and other standard musical exercises. In the history of musical pedagogy, in which the need for such evaluations becomes paramount, there has been no instance of any alternative method. At the same time, however, as noted several times, the traditional music testing environment requires the presence of a sophisticated and sensitive musical ear, which is found inconveniently on only a small number of living human heads. The musical ear is a subjective instrument of judgment.

Now, it may indeed be desirable to have an objective means of evaluation at our disposal, but certainly not at the expense of constricting the testing environment. Any practical device for the objective evaluation of a performance must allow at least for the same flexibility in its use that musicians are accustomed to expect from the traditional and conventional testing context. There, the weaknesses or strengths of the performer are revealed by give and take between the performer and the person testing. It is often desired to focus more closely on one particular feature of the performer's technique, so that some tests must be devised on an ad hoc basis. Thus, a different tempo might be requested, or two tempos in quick succession. But the Music Training Apparatus, a typical example of the devices known in prior art, does not provide any means for changing the tempo of the pre-recorded sequence, as it does not provide for adjustment of key, or meter. It also does not provide for instantaneous production of any one of an infinite number of combinations of the various sequences that it stores in its reference memory. The meager breadth of the repertoire of sequences that it can support fatally diminishes the flexibility of its use.

The Device and Method for Testing Music Proficiency, by contrast, is not limited to the small number of pre-recorded sequences of musical pitches played by the Music Training Apparatus. It will be seen in the course of the “Description” below, that the method employed by the Device and Method for Testing Music Proficiency, like that of the

Harmonic Metronome, allows for the instantaneous creation of any of the possible alterations and combinations of pitch and rhythm that are used in standard musical exercises. It accomplishes this with great ease of use. Moreover, these standard exercises are precisely those that are invariably used in the traditional music-testing context. As a practical matter, any other method would require the user either to program the device for the particular sequence of pitches and rhythms that he wants to test (inputting the pitches and rhythms step by laborious step), or to search through an unwieldy and incomplete catalog of pre-recorded sequences that are designed specifically for loading into the memory of the device, or be satisfied with a very limited testing repertoire. Any of these methods would be a fatal constraint involving too much time, and/or necessitating too much prior knowledge of MIDI programming and/or synthesizer technology, etc. And, as just demonstrated above, it would be lacking in the requisite flexibility of use.

Turning now to musical devices that may be construed specifically as music testing devices, per se, we find similar fatal limitations. For example, the Visual indicator of temporal accuracy of compared percussive transient U.S. Pat. No. 4,919,030 (Perron, III; Marius R.) is able to compare a performance to a reference, and quantifies the degree of accuracy. However, since it relates exclusively to the comparison of percussive transients, it is suitable only for the evaluation of rhythmic performance. It does not even attempt to measure the pitch element in a musical performance. Needless to say, it also does not provide for instantaneous user modification of the pre-recorded rhythmic reference sequences that it incorporates into its design. It also does not provide for an overall evaluation of the performance, indicating for instance exactly what was the percentage of rhythms played correctly by the performer. Instead, it measures and evaluates only the individual musical events in the sequence.

A device called, Dynamic display for automatic sound signal analyzer, U.S. Pat. No. 4,589,324, (Aronstein; Jesse) is a testing device that suffers from the opposite limitation. Whereas the previous device measures and evaluates only the rhythmic elements in a performance, this device measures and evaluates only the pitched elements. Again, this would be a fatal limitation in a comprehensive Device and Method for Testing Music

Proficiency. Moreover, the device plays pitches as they are selected by the user, and there are no pre-recorded sequences. Therefore, needless to say, this device also does not provide for instantaneous user modification of a full repertoire of musical sequences. Instead, the user proceeds pitch by pitch during the course of the testing session. It is important to note again here that this device tests and displays an evaluation of the accuracy of pitch in performance, but only for each individual pitch as it is played, and taken as a single event. This device does not attempt to evaluate the performance of the sequence as a whole. It gives, for example, no statistical measure of how many of the pitches in the entire collection of pitches performed during the testing session were correct, what their percentage was of the whole, etc.

Another testing device does not have this disadvantage of proceeding only on a pitch by pitch basis, but its particular limitation is almost as extreme. In the device called Indicator apparatus for indicating notes emitted by means of a musical instrument, U.S. Pat. No. 4,434,697 (Roses; Henri), it is possible to perform various sequences of pitches, and even to determine the rhythmic intervals between the pitches. But the device does not measure metronomic accuracy in the performance of the pitch. So long as the pitch is played at some point within the time period designated for it, it is considered valid and accurate. The precise moment when the pitch is initiated by the player in the performance is not compared to a metronomic standard. Therefore, accuracy in the rhythmic performance cannot be measured and evaluated, and the output display is wholly devoted to reflecting the accuracy of pitch in the player's performance. However, it is also important to note that it tests and displays an evaluation only of the accuracy of pitch performance for each individual pitch in the sequence and does not attempt to evaluate the performance of the sequence as a whole. It gives, for example, no statistical measure of how many of the notes in the sequence were correct, and what their percentage was of the whole, etc. Needless to say, the device also does not provide for instantaneous modification of its given sequence of pitches according to standard performance parameters, including tempo, meter, and key. It also does not provide for instantaneous production of any one of an infinite number of combinations of the various sequences that it stores in its memory. Turning now to patents for automatic accompaniment devices, various kinds of automatic accompaniment devices have been patented. Some require input by the user of the specific pitches to be played, even though this is highly impractical. An Electronic musical instrument adapted for sounding rhythm tones and melody-tones according to rhythm and melody play patterns stored in a timed relation to each other, U.S. Pat. No. 4,742,748 (Tateishi; Naofumi), is a representative example. It also does not allow for modification of the sequence after it is composed by the user and stored in memory. This device uses a musical keyboard, but does not provide for input of information from any of the other standard instruments of the orchestra, or the voice.

There are, of course, automatic accompaniment devices that do provide for such input. For example, consider an Apparatus and method for analyzing vocal audio data to provide accompaniment to a vocalist U.S. Pat. No. 5,693,903 (Heidorn; Allen J.) This device is typical of automatic accompaniment devices that rely on feedback from the live performer, and it is designed to synchronize its performance to the rhythmic inflections (speeding up and slowing down) produced by the live performer. A music-testing device requires precisely the opposite. It demands that the live performer synchronize as precisely as possible with the mechanical device, and then it measures and evaluates the degree to which that is actually accomplished.

Thus, it must be understood that automatic accompaniment devices serve a function completely unrelated to testing musical proficiency (although they can surely be used as another kind of tool in practice for acquiring musical proficiency). Whatever the sequences of pitches and rhythms produced by an automatic accompaniment device may be, its purpose is not to produce them as an absolutely accurate reference of rhythm and pitch for comparison to a live performance by a musician. It is not meant to abide by the regularity of ordinary metronomic constraints. In fact, it is preferable, and even essential, that it does not. Automatic accompaniment devices are able to, and must, actually disguise their use of the metronome so as to mimic natural performance, which is not metronomic. Also, it is preferable if the automatic accompaniment does not play precisely the same sequences of pitches and rhythms that are played by the performer, something that is necessarily required of a testing device. The automatic accompaniment device plays sequences that are only meant to accompany the performer. Finally, it should be said that, in fact, no automatic accompaniment device is designed to evaluate, let alone to make a report to, the performer about the level of accuracy in the performance.

It may perhaps go without saying that an automatic accompaniment device does not retain in memory a repertoire of the specific and standard musical exercises that are commonly used in the testing of musical proficiency. For example, it is not designed to produce consistent sequences of specific musical scales in a logical and specific order. Such a result would be manifestly unmusical, and therefore provide a very poor musical accompaniment for live performance. Therefore, obviously, it also does not allow for the combination of those musical exercises at will, and for their modification. Automatic accompaniment devices are designed to be suitable for use in the context of public performance. In this sense, Karaoke devices are exemplary of the type. In essence, they have nothing to do with music-proficiency testing. (There are also computer software examples of automatic accompaniment for musical performance. Band in the Box, for Windows PC, is a typical example.)

In summary, all of the devices construed as prior art in this discussion suffer from one or another, or several of the following fatal limitations:

1. The device measures only the rhythmic element in music.

2. It measures only the pitched element in music.

3. The device can be used only with the aid of a MIDI-piano keyboard, or some other special device.

4. The device does not store sequences of perfectly timed and tuned pitches.

5. The device does not store a comprehensive repertoire of those sequences of perfectly timed and tuned pitches that correspond to all of the traditional musical exercises used in conventional music testing situations. Nor does it allow for their instantaneous arrangement in an infinite number of combinations, and according to user-controlled modification of standard performance parameters, including tempo, meter, and key.

6. The device measures, and/or evaluates, and/or displays data referring only to individual musical events, and does not evaluate the performance as a whole—say, for example, with an indication of what percentage of the pitches played in the entire sequence or testing session were correct.

7. The device does not produce an evaluation at all.

8. The device is suitable only for testing elementary musical skills, and is therefore of no use to the advanced musician. This applies to all of the music testing devices and software discussed herein, with the exception only of the Device and Method for Testing Music Proficiency.

Moreover, each and everyone of these limitations must be overcome in order to provide a practical method and means for testing musical proficiency in performance. In short, this is the critical standard defining term comprehensive in this context. In fact, none of the devices deemed as related in this summary (i.e. conventional metronomes of all kinds, including the Harmonic Metronome, musical tuners of all kinds, the various music-testing devices, and the automatic accompaniment devices) have been designed as a means for generalized and comprehensive testing of musical performance.

It has been already noted that the Harmonic Metronome provides the specific method on which a practical testing device has here been constructed. Of course, the Harmonic Metronome patent does not specify or claim a feedback mechanism such as described above with regard to some kinds of testing, tuning devices, and auto-accompaniment devices. Therefore, the current invention of the Device and Method for Testing Music Proficiency could best be described as a Harmonic Metronome with the addition of a means for feedback, a means for the analysis of that feedback, and a means for reporting on or displaying that analysis. But it is also important to understand that these two inventions are the only inventions in the public record that employ a “method for producing a plurality of musical exercises, including scales, arpeggios, and etudes,” these exercises then modified at will according to key, tempo, meter, and other parameters of performance. From a musical point of view, there is simply no other viable principle of design. Because of this essential fact, both the Harmonic Metronome and the Device and Method for Testing Music Proficiency have no prior art of a disqualifying nature in this very decisive respect.

### Objects and Advantages

As may be surmised from the above, the Device and Method for Testing Music Proficiency described in this specification provides answers to the age-old deficiencies inherent in all prior means and methods of musical performance evaluation. As noted, the traditional approach has until now required the presence of a sensitive musical ear. And as frequently noted in a great many places and contexts, all biological sensing and testing procedures are subjectively limited by inescapable barriers to consistency and fineness of judgment.

Only mechanical devices provide objective means for measurement and evaluation in every field of human endeavor; and the only limitation to the application of this principle has been the small number of endeavors for which an objective measure is conceivable or practical. The performance of music is one notable example of an activity that does not admit of objective measurement and evaluation. This fact has always been interpreted in keeping with a generalized tendency to turn necessities into virtues. However, it is not to be assumed that objective measurement and evaluation in the field of music is undesirable, for the accomplished musician strives for a degree of physical control that is not inferior to the machine, but in fact superior to it. At any rate, the ability to play rhythms with metronomic precision is the prerequisite to playing them with non-metronomic human expression. This is why all serious musicians own and use a metronome of one kind or another. The missing element in the world of music has not been the desire for objective measurement and evaluation, but the means to accomplish it.

A general-purpose Device and Method for Testing Music Proficiency must address the issue of measuring, evaluating, and reporting on the degree of accuracy achieved in the performance of any one of the musical instruments of the orchestra, or of the voice, as well as a large assortment of newly developed electronic instruments. A practically useful music-proficiency-testing device must test, at very least, the ability of the performer to play, at the right moment, the right pitch. It must be employed in the context of a performance of a wide-ranging collection of musical exercises, chosen at will. The report it generates must be comprehensive as well, indicating the level of proficiency achieved over the course of the entire test.

The current invention provides the first objective means for the comprehensive measurement and evaluation of musical performance. Respecting the dual musical realms of rhythm and pitch simultaneously in the electronic evaluation of a musician's (or musicians') performance of various sequences of musical scales, arpeggios, and other standard musical configurations, the current invention has universal application in the field of music. It specifies a method and means for testing musical performance on any instrument (including the voice), at any skill level, and in any context in which analysis and evaluation play a role—for example,

in self-study or study with a teacher;

in schools where evaluations and grades based on subjective measures have heretofore resulted in much confusion, argument, and discontent;

in the practical organizational conduct of ordinary performance ensembles, such as orchestras or bands where positions within the ensemble are awarded according to merit (or, rather, until now, awarded according to the highly contested measurement and evaluation of said merit by subjective individuals);

and, in professional organizations, such as unions or guilds of professional musicians, where players are admitted only if they can demonstrate a certain level of practical proficiency.

### Drawing Figures

FIG. 1a shows a typical configuration of the various components of the Device and Method for Testing Music Proficiency.

FIG. 1b shows the User Control Panel

### REFERENCE NUMERALS IN DRAWINGS

1. Power Source

2. Microprocessor

3. User-Configuration Display and Input Panel

4. Microphone Audio Input

5. Digital Signal Processor (DSP)

6. Audio Reproduction and Output Speakers

7. Output Printer or Video

8. Memory Means

9. Display Screen

10. SELECT Button

11. ENTER Button

12. TEST Button

13. SETUP Button

14. Power Switch

### DESCRIPTION

The components of the Device and Method for Testing Music Proficiency serve to accomplish three main objectives. These pertain to the three basic functions of the device: 1) recording or registering the performance; 2) evaluating it; and 3) reporting on it.

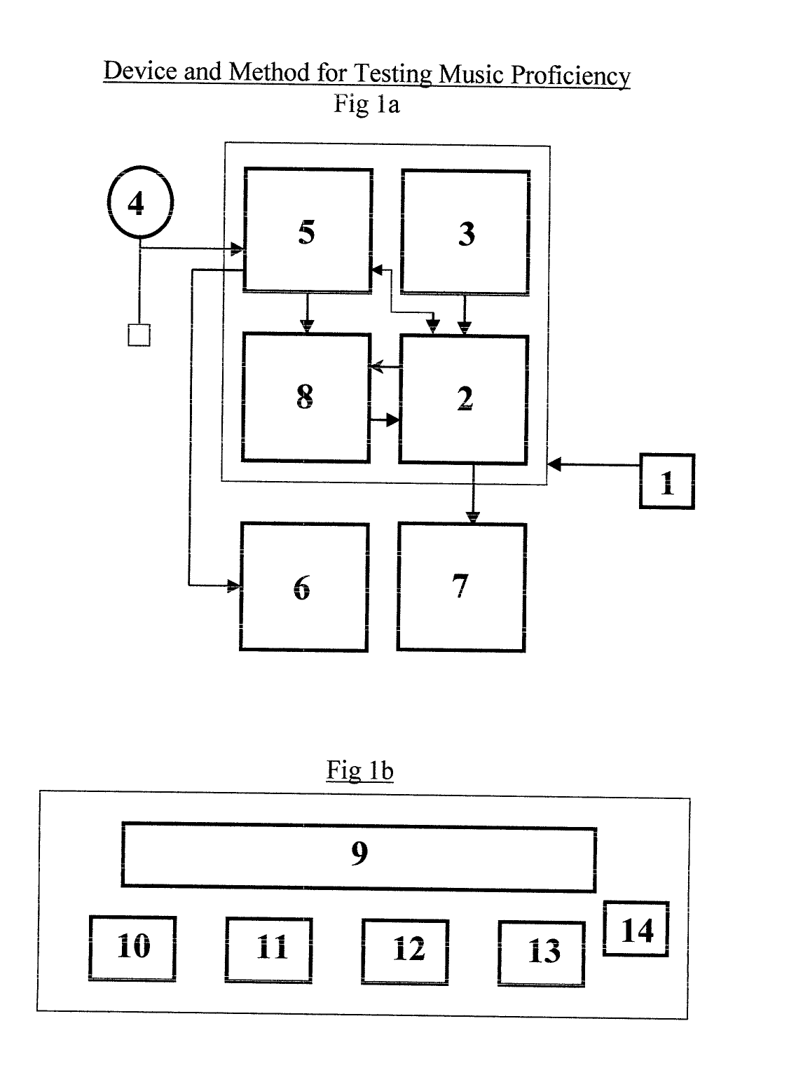

In FIG. 1a, The Microphone (4) together with the DSP (5) comprise the first function of the device which is to gather and collect information from the live musical performance of the musician being tested. In the drawing, a microphone is used specifically to register the wave patterns of air pressure that are created by the instrumentalist who is being tested. These patterns of air-pressure are electronically translated by the microphone into the shape of an analog audio signal that feeds directly into the DSP (5) of the Device and Method for Testing Music Proficiency.

It should not be assumed, however, that the microphone represents the only form in which information about the musician's performance may be taken into the device. In should be noted that the word “information” is used here in the broader sense. It encompasses an analog audio signal from a microphone, or from the output of an electronic instrument, or mixer, or amplifier, etc., or a digital signal, or any of the other mechanical and/or electronic means of facilitating the input of information to the system, may also be used. For example, a typical MIDI-capable keyboard or other electronic instrument may transfer the information by means of a MIDI signal, and without the use of a microphone.

In the present instance, as indicated, the sound of the musical performance is translated into an electrical analog audio signal by means of the Microphone (4). The DSP (5) functioning as a typical Analog/Digital Converter, converts this analog signal into a digital signal, creating digital information which is then copied and stored in Memory (8). In this way, the DSP (5) translates the shape of the electronic signal from the Microphone (4) into a form of digital information that can be read, analyzed, and evaluated by the CPU (2), which performs the second function of the device.

Now, the information in Memory (8) reflects the shape of the analog signal transmitted to the Device and Method for Testing Music Proficiency by the Microphone (4), and after its conversion by the DSP (5) into a corresponding digital signal. The CPU (2) analyzes that digital signal to determine which pitches were played and when. In the device's second function the CPU (2) compares the resulting information with standardized reference information stored in Memory (8).

On the basis of this comparison, the CPU (2) generates a test report according to its internal programming, which is sent for output to the Output Printer (7). The printing of a report fulfills the third and final function of the device. (Once again, it should not be assumed that a printer provides the only means for output of the report from the CPU (2). A video monitor would be an example of an equally practical means for display of the report. Or, multiple outputs may also be employed, including video, audio, and printed results.)

The report details the incidence and degree to which the information from musician's performance deviates from a perfectly timed and tuned performance. Naturally, the report may extend itself to any level of analysis, showing, for example comparable results from other test subjects, according to the age of the performer, years of study, the setting of the performance, etc. Recommendations for improvement may be included. Any and all responses to the evaluation of the performance may be considered as within the purview of the report generated by the CPU (2).

### OPERATION

The Device and Method for Testing Music Proficiency may be used in a great variety of places and situations, privately or professionally, in the course of formal study, or in many other ways as the context requires. In the embodiment of the invention reflected in FIG. 1a and FIG. 1b, the performing musician simply situates himself/herself within range of the Microphone (4) and plays a pre-determined schedule of scales, and/or arpeggios, and/or other musical exercises or configurations.

Before its testing functions may be activated, however, the Device and Method for Testing Music Proficiency must be configured, and this configuration must of course correspond to the same predetermined schedule of musical scales, arpeggios, and other exercises referred to in the paragraph above. This configuration is done completely in accordance with the wishes of the person taking and/or giving the test, and may be set within an infinite range of possibilities.

It must be understood, that the Device and Method for Testing Music Proficiency does not test just anything that the musician may choose to play. The Device and Method for Testing Music Proficiency compares the musician's performance of a specific sequence of rhythms and pitches against the objective standard of a perfectly accurate performance of that same sequence. The device must therefore be set for the sequence that is to be played. This should not be construed as a limitation, however, since the Device and Method for Testing Music Proficiency may be configured in such an exhaustive manner, and with perfect ease.

In fact, the user-interface of the Device and Method for Testing Music Proficiency is very similar to that of the Harmonic Metronome, and thus of proven simplicity and ease of use (no MIDI or other technical knowledge is required). Test sequences are easily configured out of a pre-programmed collection of conventional scales, arpeggios, and exercises, and these are modified according to conventional performance parameters of key, meter, and tempo, etc., as desired.

In order to configure the testing device for a specific test, the user inputs the necessary information into the User-Configuration Display and Input Means (3) by selecting from a variety of options.

FIG. 1b shows the User-Configuration Display and Input Panel (3 in FIG. 1). It consists of a Display (9), and four Buttons: SELECT(10), ENTER(11), TEST(12), and SETUP(13), plus the Power Switch (14). (Of course, in practice, it might also include a mechanical Key, a Data Entry Slider, a Data Wheel, and/or any other typical devices for facilitating information input.)

When the user first moves the Power Switch (14) from OFF to ON, the Device and Method for Testing Music Proficiency displays the MODE page on the Display (9). A “page” refers to a list or menu of operational options that are displayed on the display for selection by the user. (The Display (9) may also be any one of all of the various available devices, such as for example, LCD, a video or touch-sensitive screen.)

In this particular embodiment, the MODE page allows the user to select between two specific options: Scales and Arpeggios, or Exercises. The SELECT Button (10) is used to move a highlight or cursor between the two options, and the ENTER Button (11) is used to choose one of the options.

When the Scales and Arpeggios option is highlighted and the ENTER Button (11) is pressed, the Display (9) moves to the SCALES AND ARPEGGIOS page. This page contains a list of all the possible musical scales and arpeggios that are available for testing by the system. For example, the following options may be listed:

Major Scale, Mayor Arpeggio

Lydian Scale, Lydian Arpeggio

Lydian Augmented Scale, Lydian Augmented Arpeggio

Augmented Scale, Augmented Arpeggio

Harmonic Major Scale, Harmonic Major Arpeggio

Major Pentatonic Scale, Major Pentatonic Arpeggio

Diminished Scale, Diminished Arpeggio

Dorian Scale, Dorian Arpeggio

Natural Minor Scale, Natural Minor Arpeggio

Harmonic Minor Scale, Harmonic Minor Arpeggio

When the SCALES AND ARPEGGIOS page first appears, the first item on the list is highlighted. The SELECT Button (10) is used for scrolling the highlight through the list of options, and the ENTER Button (11) is used to choose the desired option from the list.

Upon pressing the ENTER Button (11) a second time, the OCTAVE page appears on the Display (9). This page displays the following list of options:

1 octave

2 octaves

3 octaves

4 octaves

When the OCTAVE page appears, the first item in the list is highlighted. Again, using SELECT Button (10), the user selects the desired option from the list. Pressing the ENTER Button (11) chooses the option.

After pressing the ENTER Button (11) a second time, the KEY page appears on the Display (9). Using the above-described method, the user may select a different tonal center or key from the KEY page, which displays the following list of options:

C-sharp

D

D-sharp

E, etc. through B

Pressing the ENTER Button (11) chooses the selected option. When the ENTER Button (11) is pressed a second time, the following TEMPO page appears on Display (9):

20 bpm (beats per minute)

25 bpm

30 bpm

35 bpm

40 bpm

45 bpm

50 bpm, etc. through 240 bpm

In the above-described manner, pressing the SELECT Button (10), the user makes a selection from the TEMPO page. Pressing the ENTER Button (11) chooses the selected option. After pressing it a second time, the following METER page appears on Display (9).

2/2, 2/4, 2/8

3/2, 3/4, 3/8

4/2, 4/4, 4/8

6/4, 6/8, 9/8

Proceeding in a similar manner on the METER page, the user selects the desired option, and then the following LOOP page appears on the Display (9):

Repeat once

repeat two times

repeat three times, etc. through repeat ten times

The LOOP page allows the user to program a schedule of repetitions for the previously selected sequence. Specifically, after the user selects, in this example, the Lydian scale, in four octaves, in the key of B-flat, at a tempo of 70 beats per minute, the user may then also choose the repeat two times option on the LOOP page. In this way, the Device and Method for Testing Music Proficiency is configured for a test in which the Lydian scale is to be played twice, in four octaves, in B-flat, at 70 bpm. If at this point, the ENTER Button (12) is pressed again, the user is returned to the MODE page, and may continue to add elements as desired to the test sequence.

The Music Proficiency Testing Device is then ready for use. After pressing the TEST Button (12), the device plays eight preparatory beats to cue the entrance of the performer, who is stationed in front of the Microphone (4). The performer is asked to play the same sequence of scales and/or arpeggios that has just been selected for the test in the manner described above.

Alternatively, and in a manner analogous to that described above, a great variety of other kinds of standard musical exercises may be selected for testing by selecting the Exercises option on the MODE page. The operation of the Device and Method for Testing Music Proficiency is correspondingly simple and direct.

### SUMMARY RAMIFICATIONS, AND SCOPE

Thus, the reader will see that the Device and Method for Testing Music Proficiency provides a unique and unprecedented device for use in the testing, analysis, and evaluation of musical proficiency. It fulfills a need for objective evaluation in a field where subjective evaluations have heretofore been the norm. It will greatly simplify the task of clearly defining standards of musical proficiency, and its usage will help to define in detailed and quantitative terms the capabilities of human physical control over musical instruments and the voice. In this way, it will become an accessory and tool in educational, professional, and amateur contexts everywhere that music is played and practiced.

While the descriptions above contain many specifics, these should not be construed as limitations on the scope of the invention, but rather as an exemplification of only one preferred embodiment thereof. Many other variations are possible. Accordingly, the scope of the invention should be determined not by the embodiment illustrated, but by the appended claims and their legal equivalents.

I claim:

1. A device for testing the technical proficiency of at least one musical performer, comprising:
(a) a powering means for providing electrical energy, and
(b) a microprocessor means for executing a pre-programmed set of internal commands in coordination with a set of user-input commands, and
(c) a user-configuration means for selecting from a plurality of pre-programmed options, and for compiling and storing on that basis said user-input commands, which are used by said microprocessor means to create and store a test sequence from a pre-programmed collection of conventional scales, arpeggios, and other musical exercises, which are modified as desired according to the standard parameters of musical performance including tempo, key, meter, volume, and timbre; and
(d) an audio input means for receiving an audio signal from a performance by at least one musician of said test sequence; and
(e) a digital signal processing means for creating and storing a first digital audio wave that represents a perfectly timed and perfectly tuned mechanical reproduction of said test sequence, and, for creating and storing a second digital audio wave corresponding to said audio signal, converting said audio signal from an analog to a digital format if necessary; and
(f) an audio-reproduction means for making said first digital audio wave humanly sensible, if desired; and
(g) an output means for displaying and/or presenting an evaluation of said performance, based on a comparison and analysis of said first digital audio wave and said second digital audio wave; and
(h) a memory means for storing and retrieving said user-input commands, said test sequence, said audio signal, said first digital audio wave, said second digital audio wave, and said evaluation.

2. The testing device of claim 1, wherein said output means include written or graphic visual displays, audio speakers, video screens, printers, LED or LCD displays, and tactile receivers.

3. The testing device of claim 1, wherein said user-configuration means include computer(s), the Internet, and telephone and wireless communications.

4. The testing device of claim 1, wherein said audio input means include analog, digital, and optical connectors, microphones, line input from audio playback devices including CD and tape, electronic instruments, MIDI input from MIDI devices, computer networks, the Internet, and telephone and wireless communications.

5. The testing device of claim 1, wherein said digital signal processing means include AD and DA converters, effects processors, and synthesizer modules.

6. The testing device of claim 1, wherein said memory means include RAM, ROM, magnetic media, hard disks, and tape drives.

7. The testing device of claim 1, wherein said memory means store instrumental samples for playing said first digital audio wave.

8. The testing device of claim 1, wherein said audio reproduction means include audio speakers, headphones, and audio equipment of all kinds including recorders and effects processors.

9. The testing device of claim 1, further including a metronome to be played in sync if desired along with said first digital audio wave.

10. The testing device of claim 1, further including a printer for making a certificate testifying to a performer's level of proficiency.

11. A method for testing the technical proficiency of at least one musical performer, comprising the steps of:
(a) creating, storing, and retrieving a perfectly timed and perfectly tuned test sequence, in the form of a first digital audio wave, out of a pre-programmed collection of conventional scales, arpeggios, and other musical exercises, said test sequence being modified at will according to the standard parameters of musical performance including, tempo, key, meter, volume, and timbre; and
(b) making said test sequence humanly sensible, if desired; and
(c) receiving and storing an audio signal derived from a performance of said test sequence by a musician; and
(d) converting said audio signal into a second digital audio wave, and storing it; and
(e) analyzing said first digital audio wave, and comparing it with said second digital audio wave; and
(f) producing thereby an evaluation of the performance with reference to objective standards of proficiency; and
(g) making humanly sensible said evaluation.

12. The method of claim 11, further including a means for adjusting the key transposition of said test sequence in the event that transposing instruments are being performed.

13. The method of claim 11, further including a means for choosing an instrumental timbre for the output of said test sequence.

14. The method of claim 11, further including a means for changing the volume and tone of said test sequence

15. The method of claim 11, further including a means for recording said digital audio waves.

16. The method of claim 11, further including a means for displaying a musical score of said test sequence.

17. The method of claim 11, further including a means for keeping track of evaluations received in the performance of said test sequences, for generating competitive games, making rewards, and facilitating competition between players.

18. The method of claim 11, further including a means for organizing a series of said test sequences for pedagogical or practical purposes.
